(19) United States
(12) Patent Application Publication
(10) Pub. No.: US 2006/0102556 A1
(43) Pub. Date: May 18, 2006

(54) Porous molecularly imprinted polymer membranes

(76) Inventors: Sergey Anatoliyovich Piletsky, Cranfield (GB); Olena Volodimirivna, Cranfield (GB); Anthony, Peter Francis Turner, Milton Keynes (GB); Philip James Sergeyeva, Milton Keynes (GB); Tetyana Anatolivna Elska, Kiev (UA); Olexandr, Olexandrovych Brovka, Kiev (UA); Ganna Valentinivana Elska, Kiev (UA)

Correspondence Address: STITES & HARBISON PLLC, 1199 NORTH FAIRFAX STREET, SUITE 900, ALEXANDRIA, VA, 22314, US

(21) Appl. No.: 10/521,199

(22) PCT Filed: Jul. 11, 2003
(86) PCT No.: PCT/GB03/03046

§ 371 Date: Sep. 21, 2005

(30) Foreign Application Priority Data
Jul. 13, 2002 (GB) 0216333.5

(51) Int. Cl. B01D 71/28

(52) U.S. Cl. 210/500.34; 210/500.35; 210/500.42

(57) ABSTRACT

Highly porous substance-selective polymeric membranes are produced by co-polymerisation of functional monomers and cross-linker in the presence of template, plasticiser (non-extractable component), and pore-forming component (extractable component). Extraction of the template and porogen molecules leads to the formation of small (<100 nm) and large (>500 nm) pores, including small pores having a shape and arrangement of functional groups complementary to the template molecule. The membranes possess enhanced affinity towards the template and its analogues and also have high flexibility and porosity. Such membranes can be used in analytical chemistry (as sensor elements and for solid-phase extraction materials) for applications in pharmacology, medicine, the food industry, water purification and environmental clean up.

### TECHNICAL FIELD

The present invention relates generally to molecularly imprinted polymer materials, to their synthesis and to their applications, e.g. in solid-phase extraction, separation, purification and sensing of organic molecules.

### BACKGROUND ART

Over the last three decades, new “molecular imprinting” approaches for introducing affinity binding sites into synthetic polymers have been developed [1A, 1B, 2]. Typically, a highly cross-linked polymer is formed around a template molecule. The template is then removed by washing and a cavity with functional groups complementary to those of the template molecule remains behind in a polymer. It has been shown that molecularly imprinted polymers (MIPs) can be developed for a variety of compounds [3, 4] and their synthesis can be a straightforward and inexpensive procedure. These polymers demonstrate very good thermal and mechanical stability and can be used in aggressive media [5]. Therefore, the molecular imprinting approach allows one to combine the ability of a natural receptor to bind an analyte selectively with the stability and robustness of synthetic polymers.

MIPs have been widely used as stationary phases for chromatographic separation [6, 7], as substitutes for antibodies in immunoassays [8, 9], and as selective elements for electrochemical sensors [10, 11] and solid-phase extraction (SPE) [12-14].

Chromatographic and SPE applications have used MIP particles prepared by grinding and sieving of synthesised polymer blocks, or particles prepared by suspension polymerization. The first approach is time consuming, can lead to destruction of some binding sites in the polymer and produces a relatively low yield of a fraction with a narrow size distribution as required for the practical application. In the second approach, the choice of monomers is limited to those which are not soluble in the dispersion phase. Additionally the synthesised beads are also not uniform in their shape and size. Therefore, again a tedious sieving procedure is required to obtain uniformly sized particles for packing. As a result, the packing of a column with MIP is time-consuming, expensive and ineffective. Other less conventional approaches to improve the quality of HPLC materials and facilitate the preparation procedure have been tried. Thus Kumakura et al. [15] disclose a porous polymer composite column produced by radiation casting polymerisation. Matsui et al. [16] describe the preparation of porous MIP rods in situ inside HPLC columns. This approach, however suffered from quality control problems (too many synthesised columns have defects) and often too high a backpressure. U.S. Pat No. 5,334,310 discloses columns of macroporous media.

Potentially chromatography can be performed on membranes. For example, U.S. Pat. Nos. 4,889,632, 4,923,610 and 4,952,349 disclose chromatography on thin layer macroporous membranes punched from a macroporous sheet of polymer. The difficulty in designing MIP membranes for chromatography and filtration is twofold: (i) the high level of cross-linking generally used in molecular imprinting results in the formation of too fragile and brittle a membrane; and the membranes are of relatively low porosity. The problem of membrane fragility has been resolved by adding plasticiser to the polymer composition—oligourethane acrylate [17]. The cast membranes were flexible, but their porosity was too low for useful chromatographic separation.

### REFERENCES

1A. G. Wulff, Angew. Chem. 107 (1995) 1958.
1B. A. G. Mayes, K. Mosbach, Trends Anal. Chem. 16 (1997) 321.
2. 0. Ramstrom, I. A. Nicholls, K. Mosbach, Tetrahedron Assym. 5 (1994) 649.
3. M. Siemann, L. I. Andersson, K. Mosbach, J. Agric. Food. Chem. 44 (1996) 141.
4. D. Kriz, K. Mosbach, Anal. Chim. Acta 300 (1995) 71.
5. G. Wulff, S. Schauhoff, J. Org. Chem. 56 (1991) 395.
6. P. K. Owens, et al. Trends. Anal. Chem. 18 (1999) 146.
7. S. A. Piletsky et al. Macromolecules, 35, (2002) 7499.
8. G. Vlatalis, et al. Nature 361 (1993) 645.
9. S. A. Piletsky, et al. Biosens. & Bioelectron. 10 (1995) 959.
10. T. A. Sergeyeva, et al., Analyst 124 (1999), 331.
11. C. Baggiani et al. J. Chromatogr. A, 938, (2001), 35.
12. K. Moller, U. Nilsson, C. Crescenzi, J. Chromatogr. A, 938, (2001), 21.
13. K. Jinno et al. J. Chromatogr. A, 754, (1996), 137.
14. D. K. Roper, E. N. Lightfoot, J. Chromatogr. A, 702 (1995), 171.
15. Kumakura et al. J. Mat. Sci. 24 (1989), 1809.
16. J. Matsui et al. Anal. Chem. 65 (1993), 2223.
17. T. A. Sergeeva et al. Anal. Chim. Acta 392 (1999), 104.

### DISCLOSURE OF THE INVENTION

The present invention is focused on the development of imprinted membranes, preferred embodiments of which are mechanically stable, flexible and porous and suitable for application in filtration and chromatography.

The present invention provides a flexible porous membrane made of molecularly imprinted polymer. The MIP membrane may be useful as a chromatographic medium. Alternatively or additionally it may find application in various separation, catalytic, diagnostic, and absorption processes, owing to its affinity, selectivity and ability to pass liquids therethrough. The polymer desirably contains not only small pores, e.g. those below about 100 nm in diameter, but also large pores, e.g. those at least 500 nm in diameter. The flexible porous MIP membrane is produced by co-polymerisation of functional monomers and a cross-linker in the presence of a template, plasticiser (non-extractable component), pore-forming component (extractable component) and, in most cases, an initiator. The porogen may be selected so that it produces large, transmembrane pores. The polymerisation is performed in a thin layer, which may be confined between transparent or non-transparent articles, which will define the geometry, to some degree morphology, and thickness of the formed film. The pore-forming component, template, and non-reacted monomers, cross-linker, and initiator if used may then be removed with a suitable solvent.

Two possible mechanisms of porogen induced pore formation can be proposed though the invention is not dependent on their correctness. Similarly to the effect the of “poor” solvents, a porogen such as a linear polymer, e.g. PEG, facilitates phase separation between the growing co-polymer chains and a solvent, containing dissolved linear PEG, by increasing the level of their thermodynamical incompatibility. The pores are formed between the coalescent cross-linked polymer globules. Another likely mechanism involves formation of different microregions in the polymer structure. Due to high molecular weight of a polymer such as PEG used in this system, the phase separation is not complete. Therefore heterogeneous microphase non-equilibrium structures are formed that remain stable during unlimited time and form a semi-interpenetrating polymer network (semi-IPN) between the cross-linked co-polymer and polyethylene glycol. Incomplete phase separation in a fully formed IPN or semi-IPN leads to the appearance of interphase or transitive regions, which have more “defect” and porous structure as compared to the structure of pure individual components of IPN. The semi-IPN represents a four-phase system consisting of microregions of the co-polymer, microregions of the linear polymer (PEG), microregions of the co-polymer enriched with the linear polymer, and microregions of the linear polymer enriched with the co-polymer. Apparently, extraction of the linear polymer from the different regions of the polymerized membranes will result in formation of pores with wide size distribution.

### BRIEF DESCRIPTION OF THE DRAWINGS

FIG. 1 is a bar chart illustrating the use of an embodiment of the invention.

FIGS. 2 A and B are a pair of scanning electron microphotographs of membranes produced in the absence and presence, respectively, of porogen.

### MODES FOR CARRYING OUT THE INVENTION

In a first aspect, the invention is a composition for preparation of a flexible and porous MIP membrane. It generally contains: functional monomers, a template substance, crosslinker, plasticiser (non-extractable component), pore-forming component (extractable component) and initiator. The role of the functional monomers lies in providing functionalities capable of interacting with the template through, preferably electrostatic (ionic and hydrogen bond), van-der-Waals, dipole-dipole, charge transfer, reversible covalent or hydrophobic interactions. The template interacts with functional monomers and forms a complex, which will be integrated into the polymer network formed during polymerisation. The template directs positioning of functional monomers and creates in the resulting polymer specific binding sites, or imprints. The role of the cross-linker lies in the formation of a three-dimensional network capable of preserving some structural features of the monomers and their orientation as it exists in the complex formed with the template. The cross-linked polymer network will maintain and preserve the imprints (cavities with a shape and an orientation of functional groups complementary to those of the template molecules). The role of the plasticiser lies in providing a certain level of flexibility to an otherwise rigid polymer network. In some embodiments the plasticiser will be co-polymerised with the monomers and cross-linker, forming a covalently bound network. In other embodiments the plasticiser will form only physical bonds (interpenetrated polymer network) with monomers and cross-linker. The role of the pore-forming component lies in the formation of large open and closed pores in the polymer matrix, suitable for effective transport of solution, which is required for chromatographic application of these membranes. The initiator generates free radicals (in radical polymerisation) or ions (in ionic polymerisation).

Suitable monomers and cross-linkers may be selected from vinyl, allyl, styrene, acrylic or (meth)acrylic derivatives, with non-exclusive examples of divinylbenzene, divinylnaphthalene, vinylpyridine, hydroxyalkylene methacrylates, ethylene glycol dimethacrylate, vinyl esters of carboxylic acids, divinyl ether, pentaerythritol di-, tri-, or tetramethacrylate or acrylate, trimethylopropane trimethacrylate or acrylate, alkylene bis acrylamides or methacrylamides, methacrylic and acrylic acid, acrylamide, hydroxyethyl methacrylate, and their mixtures. The monomers and cross-linker are generally present in the polymerisation mixture in an amount of from about 10 to 80 vol. %, and more preferably in an amount of from about 40 to 80 vol. %.

The template may be selected from a group including biological receptors, nucleic acids, immunosuppressants, hormones, heparin, antibiotics, vitamins, drugs or synthetic molecules possessing biological activity, cell components and components of viruses such as carbohydrates, lipids, saccharides, nucleoproteins, mucoproteins, lipoproteins, peptides and proteins, glycoproteins, glucosaminoglycanes and steroids.

The pore-forming component may be selected from a variety of different types of materials, including aliphatic hydrocarbons, aromatic hydrocarbons, esters, alcohols, ketones, ethers, butyl alcohols, isobutyl alcohol, dimethyl sulfide, formamide, cyclohexanol, saccharose acetate isobutyrate, H₂O, glycerol, sodium acetate, solutions of soluble polymers, and mixtures thereof. Suitable soluble polymers used herein include non-cross-linked polymers or copolymers of such monomers as styrene or ring substituted styrene, acrylates, methacrylates, dienes, vinyl chloride, vinyl acetate, polyvinyl chloride, polyethylene glycol, polyvinylpyrrolidone, and polyvinyl alcohol. Other possibilities include cyclohexanol and mineral oil. It may comprise one or more inorganic compounds such as salts e.g. selected from MgCl₂, Mg(ClO₄)₂, ZnCl₂, Ca Cl₂, SiO₂, NaNO₃, NaOCOCH₃ and/or NaCl. The pore-forming component may be present in the monomer mixture in an amount of from 5 to 60 vol %.

A plasticiser may be a polymerisable or non-polymerisable compound. It may be oligomeic or polymeric, e.g. oligourethane acrylate, butadiene (or isoprene) rubber, polyurethane, caoutchoucs, etc. The amount of the plasticiser is suitably from 5 to 50% (by weight) in the monomer mixture, preferably 5-20%.

Conventional free-radical generating polymerisation initiators may be employed to initiate polymerisation.

Examples of suitable initiators include peroxides such as OO-t-amyl-O-(2ethylhexyl)monoperoxycarbonate, dipropylperoxydicarbonate, and benzoyl peroxide, as well as azo compounds such as azobisisobutyronitrile, 2,2′-azobis (2-amidinopropane)dihydrochloride, 2,2′-azobis (isobutyramide)dihydrate and 1,1′-azobis (cyclohexane carbonitrile). The initiator is generally present in the polymerisation mixture in an amount of from about 0.01 to 5% by weight of the monomers.

The composition may also contain solvent (e.g. (ethyl acetate, methyl ethyl ketone, acetone, dimethylformamide, toluene, dioxane, chloroform), added for improvement of components' compatibility, improvement of the homogeneity of monomer mixture, facilitating complexation between monomers and template or for regulation polymer porosity (making it more or less porous) through the modification of the phase separation process during polymerisation.

The composition may include a matrix made of insoluble polymer, glass or ceramic matrix. This may carry an inhibitor which inhibits free radical polymerisation. This will help to create voids around solid matrix, which will be free of polymer and suited for transport of liquids and analytes. Suitable inhibitors include cupric chloride and sodium nitrite. The inhibitor is generally present in an amount of from about 0.001 to 1 wt %, based on the total weight of solid matrix. Solid matrix may be soaked in a solution of inhibitor.

The second aspect of the present invention is a method of preparation of flexible and porous MIP membranes. The process generally comprises four steps:
mixing components and (if necessary) their degassing;
forming a thin layer of mixture, e.g. by: a) confining it between articles which restrict its expansion and define the geometry and shape of resulting membrane or b) by pouring the mixture onto a surface in such a way that its becomes flat under gravity;
polymerising the mixture to form a solid porous membrane;
washing the membrane with a solvent so as to remove pore-forming component, template, non-reacted monomers, cross-linker, plasticiser and initiator.

The degassing of the mixture (needed for removal of oxygen and other dissolved gases) may be achieved by conventional means such as purging an inert gas such as nitrogen through the solution for a sufficient period of time. If the following polymerisation is performed in a thin layer between transparent or non-transparent articles, then these articles will define the geometry and to some degree the morphology and thickness of the formed film.

The polymerisation may be carried out in a conventional manner. Thermal polymerisation is generally carried out at a temperature of about 40-100° C. for a period of from about 1 to 24 hours, depending on the initiator and monomers used. In a preferable method the polymerisation is performed using UV irradiation at temperature in the range of −30° C. to +60° C.

The porogen and the polymerisation conditions (one or more of: type and concentration of monomers, temperature, pressure, quantity of porogen etc.) are selected to produce a product with large transmembrane pores and micropores, giving the desired properties.

After polymerisation is complete, the membrane is washed to remove the pore-forming component, template, non-reacted monomers, cross-linker, plasticiser and initiator with a suitable solvent. Non-exclusive examples of suitable washing solvents include methanol, ethanol, benzene, toluene, acetone, tetrahydrofuran, dioxan, acetonitrile, water and their mixtures. The washing solvent may include additives suitable for weakening template-functional monomer complexes, e.g. acid, base, salt, surfactant or chaotropic agents. The polymeric membrane synthesised as described above contains small pores (<100 nm), and large pores (>500 nm). The large pores are preferably from about 800 to 2,500 nm in diameter. The large pores desirably represent at least 10% of the total pore volume of the membrane in order to achieve a reasonable flux in chromatographic separation. The small pores generally have sizes in the range 0.1 to 200 nm. The synthesised membrane has a balance of appropriate macroporosity and physical strength to allow a liquid to pass through it under a pressure of less than 8000 PSI (56×10⁶ Nm⁻²) at a linear flow rate of at least 0.5 ml/min.

The third aspect of the present invention is the application of flexible and porous MIP membranes synthesised as described above. Applications include the use of a synthesised membrane as a separation matrix in membrane chromatography; and use in catalytic, diagnostic or absorption processes, e.g. in solid phase extraction in accordance with conventional techniques known in the art.

### EXAMPLES

The Examples are intended to illustrate, but not limit, the scope of the invention.

### Example 1

Synthesis of flexible and porous molecularly imprinted polymer membranes.

Porous thin, and flexible MIP membranes were synthesised from a mixture consisting of atrazine as a template (40 mg), methacrylic acid as a functional monomer (80.4 mg), tri(ethylene glycol)dimethacrylate as a cross-linking agent (616.6 mg), oligourethane acrylate as a plasticiser (102.9 mg), polyethylene glycol as a pore-forming component (120 mg), dimethylformamide (50 vol %) as solvent and 1,1′-azobis(cyclohexane carbonitrile) as an initiator of polymerisation (40 mg). The mixture was poured between two glass slides with a fixed distance between them of 60 μm and polymerisation was initiated by either UV-irradiation (λ=365 nm) or was carried out by heating at 80° C. for 1 hour. Reference polymeric membranes were synthesised with the same mixture of monomers, but in the absence of the template. To remove the template molecules and non-reacted monomers, cross-linker etc. and polyethylene glycol, the membrane was extracted with hot methanol in Soxhlet apparatus for 8 hours followed by washing in a hot water for a further 8 hours.

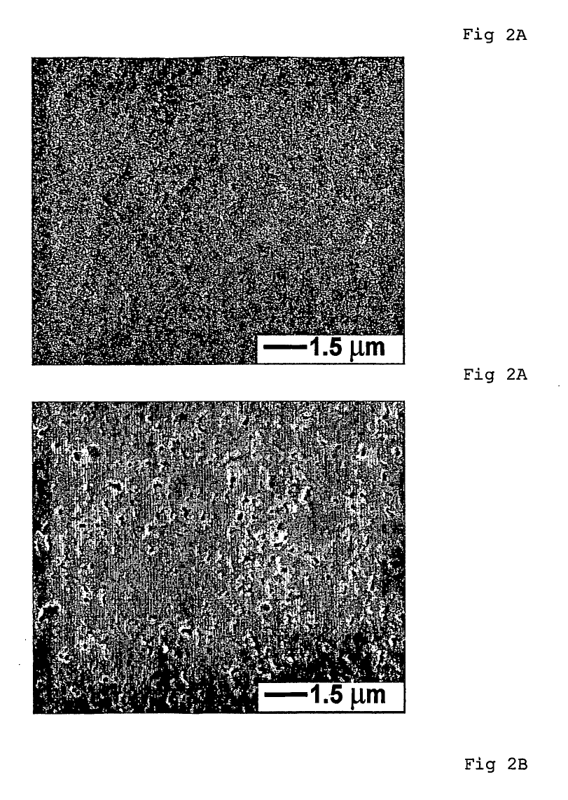

FIG. 2B shows a SEM of the membrane embodying the invention. Large pores can be seen. Compare the appearance of the membrane produced without the porogen (FIG. 2A).

### Example 2

Use of molecularly imprinted polymer membranes in solid-phase extraction of triazine herbicides.

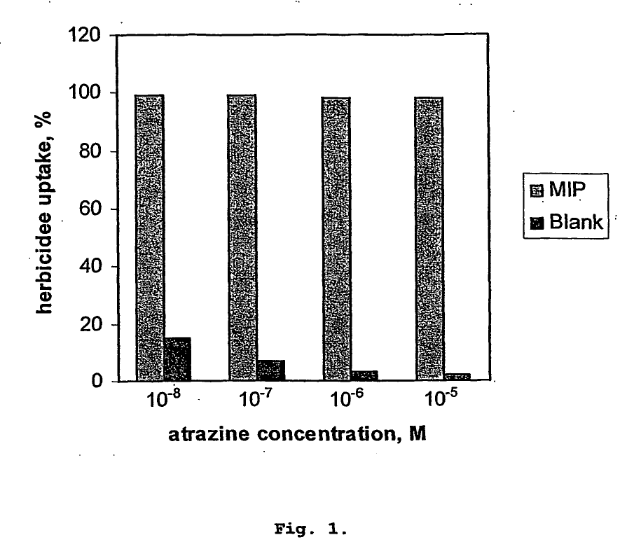

A membrane synthesised as describe in Example 1 (with atrazine template) and having a diameter of 5 mm was placed between two chambers of a separation cell. A dilute solution of atrazine was passed across the membrane at a rate 0.5 ml/min under a pressure of 17×10⁶ Nm⁻². The membrane recognition properties were evaluated by measuring their capacity to adsorb atrazine from aqueous solutions (10⁻⁸-10⁻⁵ M). The herbicide concentrations in both feed and permeate solutions were determined using Gas Chromatography-Mass Spectrometry (GC/MS). The membranes demonstrated high adsorption ability towards atrazine. Repetition using the reference membranes showed negligible binding of atrazine (see FIG. 1).

### Example 3

Synthesis of membranes imprinted with ephedrine for separation of structurally similar compounds in HPLC mode.

Porous, thin and flexible membranes were synthesized from a polymerisation mixture consisting of (+)-ephedrine as a template (40 mg), hydroxyethyl methacrylate as a functional monomer (299 mg), tri (ethylene glycol) dimethacrylate as a cross-linking agent (1106 mg), oligourethane acrylate as a plasticiser (195 mg), a mixture of porogens constituting 50% of the volume of the polymerisation mixture and containing mineral oil (160 mg) and toluene; and 1,1′-azobis (cyclohexane carbonitrile) as an initiator of polymerisation (80 mg). The mixture was poured between two glass slides with the fixed distance between them of 60 μm and polymerisation was initiated by either UV-irradiation (λ=365 nm) or was carried out by heating at 80° C. for 1 hour. Reference polymeric membranes were synthesised with the same mixture of monomers, but in the absence of the (+) ephedrine. To remove the template molecules, non-polymerised compounds, and mineral oil, the membrane was extracted with chloroform for 24 hours. The membrane synthesised (diameter 5 mm) was placed between two chambers of the separation cell and was used instead of a chromatography column filled with particles. The cell was used for the separation of ephedrine (+) and ephedrine (−) and detection was performed using UV-absorbance at 260 nm. At a flow rate of 1 ml/min, an HPLC system pressure of 21×10⁶ Nm⁻² was observed.

1. A method for synthesis of a substrate-selective membrane comprising: (a) polymerising a mixture comprising a template, at least one functional monomer, cross-linker, plasticiser and pore-forming component; and (b) extracting the template and porogen to form a flexible and porous polymeric membrane.

2. A method according to claim 1 wherein conditions are selected so that the membrane contains small (<100 nm in diameter) and large (>500 nm in diameter) pores.

3. The method of claim 1 wherein conditions are selected so that the film has a porosity of from about 25 to 90%.

4. The method of claim 1 wherein the monomers and/or cross-linker comprise one or more of vinyl, allyl, styrene, acrylic and methacrylic derivatives, and mixtures thereof.

5. The method of claim 1 wherein the plasticiser is selected from oligourethane acrylate, butadiene rubber, polyurethane, and caoutchoucs.

6. The method of claim 1 wherein the pore-forming component is selected from aliphatic hydrocarbons, aromatic hydrocarbons, esters, alcohols, ketones, ethers, solutions of soluble polymers, and mixtures thereof.

7. The method of claim 6 wherein the pore-forming component comprises one or more of; (a) soluble polymers selected from non cross-linked polymers or copolymers of monomers selected from styrene, ring-substituted styrene, acrylates, methacrylates, dienes, vinylchloride, vinylacetate, polyvinyl chloride, and polyethylene glycol; (b) glycerol; (c) cyclohexanol, and (d) mineral oil.

8. The method of any of claim 1 wherein the pore-forming component comprises insoluble macroporous polymer particles.

9. The method of claim 8 wherein said particles are cross-linked copolymers of monomers selected from vinyl, allyl, styrene, acrylic and methacrylic derivatives.

10. The method of claim 8 wherein said particles have diameters in the range 1-1000 μm.

11. The method of any of claim 1 wherein the pore-forming component is an inorganic porogen.

12. The method of claim 11 wherein the porogen comprises MgCl₂, Mg(ClO₄)₂, ZnCl₂, Ca Cl₂, SiO₂, NaNO₃, NaOCOCH₃ and/or NaCl.

13. The method of claim 1 including a further step of using the membrane as a separation matrix.

14. The method of claim 12 wherein said separation matrix is used for membrane chromatography, or for a catalytic, diagnostic, or absorption process.

15. A substrate-selective membrane as produced by the method of claim 1.

16. (canceled)

17. A separation matrix comprising the substrate-selective membrane of claim 15.
